(19) United States
(12) Patent Application Publication
(10) Pub. No.: US 2014/0192092 A1
(43) Pub. Date: Jul. 10, 2014

(54) DISPLAY DEVICE AND CONTROL METHOD THEREOF

(71) Applicant: Seiko Epson Corporation, Tokyo (JP)

(72) Inventors: Naoto Aruga, Okaya-shi (JP); Masahide Takano, Matsumoto-shi (JP); Shinichi Kobayashi, Azumino-shi (JP)

(73) Assignee: Seiko Epson Corporation, Tokyo (JP)

(21) Appl. No.: 14/101,877

(22) Filed: Dec. 10, 2013

(30) Foreign Application Priority Data
Jan. 7, 2013 (JP) 2013-000365

(51) Int. Cl. G02B 27/01; G09G 5/10

(52) U.S. Cl. CPC G02B 27/017; G09G 5/10
USPC 345/690; 345/8

(57) ABSTRACT

A head-mounted display device includes: a display section that outputs an image light to overlap with an outside light and causes an image to be viewed; a distance detecting section that detects a distance to an object positioned in a visual line direction of a wearer; and an image adjusting section that changes the image light output by the display section according to the distance detected by the distance detecting section.

### BACKGROUND

1. Technical Field

The present invention relates to a display device, and a control method thereof.

2. Related Art

In the related art, a technique that provides information to a user by a display device that displays an outside light and an image to be viewable has been proposed (for example, see JP-A-2010-210822). A device disclosed in JP-A-2010-210822 detects an identification code that is present in a visual field of a user and displays information corresponding to the detected identification code, by a head-mounted display (HMD) that causes an image light together with an outside light to be incident onto the eyes of the user. The user that uses this device views information using the image light emitted by the HMD and views an outside scene using the outside light, and thus, views an object given the identification code present in the visual field and simultaneously views information that is provided as information corresponding to the object.

In a case where the outside light and the image light overlap with each other to be viewed by the user as in the device disclosed in JP-A-2010-210822, the visibility of the outside light is changed due to the influence of the image light. Thus, it is desirable to provide a reliable technique that can favorably view the outside light and the image light.

### SUMMARY

An advantage of some aspects of the invention is to provide a display device that can favorably view an outside light and an image based on an image light, and a control method thereof.

An aspect of the invention is directed to a display device including: a display section that outputs an image light to overlap with an outside light and causes an image to be viewed; a distance detecting section that detects a distance to an object positioned in a visual line direction of a wearer; and a control section that changes the image light output by the display section according to the distance detected by the distance detecting section.

According to this configuration, since the display device changes the image light according to the distance to the object, it is possible to cause the image to be viewed while securing the visibility of the object viewed by the wearer together with the image light. Thus, it is possible to cause the outside light and the image based on the image light to be favorably viewed.

Another aspect of the invention is directed to the display device described above, wherein the control section changes the image light so that the visibility of the object is changed according to the distance detected by the distance detecting section.

According to this configuration, it is possible to appropriately adjust the image light to match the object viewed by the wearer, and it is thus possible to cause the outside light and the image based on the image light to be favorably viewed.

Still another aspect of the invention is directed to the display device described above, wherein the control section changes the intensity of the image light according to the distance detected by the distance detecting section.

According to this configuration, it is possible to omit an effort of the wearer in setting the distance to the object, for example, to enhance operability.

Yet another aspect of the invention is directed to the display device described above, wherein the control section changes the intensity of the image light on the basis of the intensity of the outside light that is incident in the visual line direction of the wearer.

According to this configuration, by adjusting the intensity of the image light on the basis of the intensity of the outside light that is incident in the visual line direction, it is possible to appropriately secure balance of the intensity of the outside light and the image light, and to cause both of the outside light and the image light to be favorably viewed.

Still yet another aspect of the invention is directed to the display device described above, wherein the control section changes a position where the image is viewed to match the visual line direction of the wearer.

According to this configuration, by setting the position of the image to a position corresponding to a visual line of the wearer, it is possible to favorably view the image despite the visual line of the wearer being changed.

Further another aspect of the invention is directed to the display device described above, wherein the display device further includes a color detecting section that detects a color of the object positioned in the visual line direction of the wearer, and the control section changes the image light on the basis of the color of the object detected by the color detecting section.

According to this configuration, it is possible to adjust the image light so that both of the outside light and the image light are easily viewed according to the color of the object.

Still further another aspect of the invention is directed to the display device described above, wherein the display device is a transmissive display device that causes a user to view an image; the display section includes an image light generating section that generates and emits image light for display of an image using display image data, and an optical member that guides the emitted image light to eyes of the user; and the outside light passes through the optical member and is incident onto the eyes of the user together with the image light.

According to this configuration, it is possible to cause the outside light and the image based on the image light to be favorably viewed by the transmissive display device in which the image light is guided to the eyes of the user by the optical member and light of an outside scene passes through the optical member and is guided to the eyes of the user.

Yet further another aspect of the invention is directed to a control method of a display device that includes a display section that outputs an image light to overlap with an outside light and causes an image to be viewed, the method including: detecting a distance to an object positioned in a visual line direction of a wearer; and changing the image light output by the display section according to the detected distance.

According to this configuration, since the display device changes the image light according to the distance to the object, it is possible to view the image while securing the visibility of the object viewed by the wearer together with the image light. Thus, it is possible to cause the outside light and the image based on the image light to be favorably viewed.

According to the aspects of the invention, it is possible to view the image while securing the visibility of the object viewed by the wearer together with the image light, and to favorably maintain the visibility of the outside light and the image based on the image light.

### BRIEF DESCRIPTION OF THE DRAWINGS

The invention will be described with reference to the accompanying drawings, wherein like numbers reference like elements.

FIG. 1 is a diagram illustrating an appearance of a head-mounted display device according to an embodiment of the invention.

FIG. 2 is a diagram illustrating a schematic configuration of an optical system of a head-mounted display device.

FIG. 3 is a functional block diagram of a control system of a head-mounted display device.

FIGS. 4A and 4B are diagrams illustrating an example in which an image is displayed by a head-mounted display device, which illustrate an example in which the visibility of an outside scene is changed.

FIGS. 5A and 5B are diagrams illustrating an example in which an image is displayed by a head-mounted display device, which illustrate an example in which a display mode of a position corresponding to a visual line direction is changed.

FIG. 6 is a flowchart illustrating an operation of a head-mounted display device.

### DESCRIPTION OF EXEMPLARY EMBODIMENTS

Hereinafter, embodiments of the invention will be described with reference to the accompanying drawings.

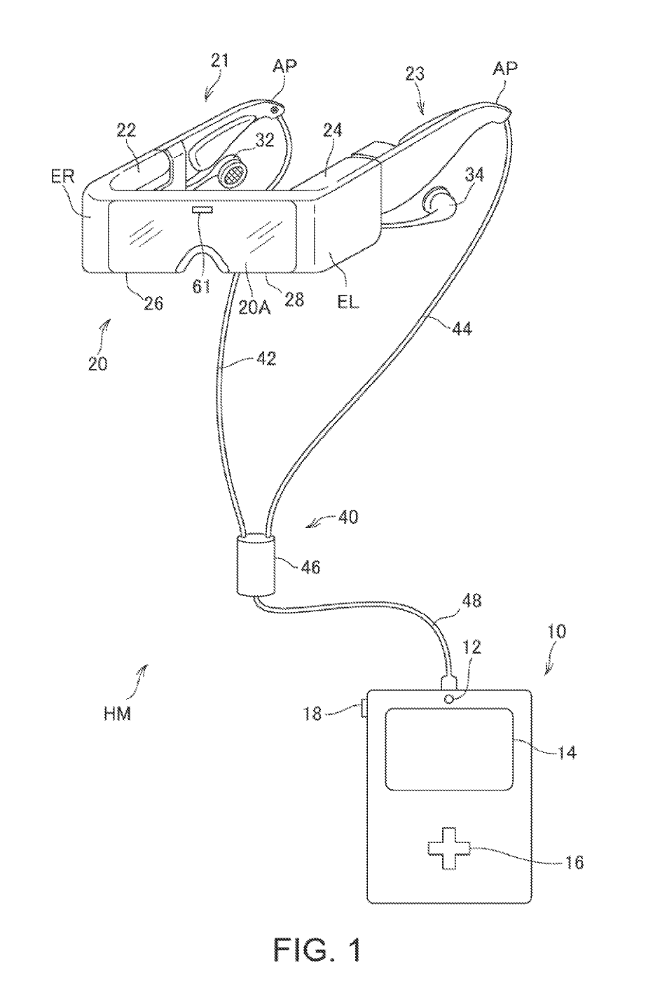

FIG. 1 is a diagram illustrating an appearance of a head-mounted display device according to an embodiment of the invention.

A head-mounted display device HM is a head-mounted display device mounted on the head of a user (wearer), and is referred to as a head mounted display (HMD). The head-mounted display device HM of the present embodiment corresponds to a light transmissive head-mounted display device through which a user can directly view an outside scene at the same time when viewing a virtual image.

As shown in FIG. 1, the head-mounted display device HM is provided with an image display section 20 mounted on the head of the user, and a control device 10 that controls the image display section 20. The image display section 20 includes a right holding section 21, a right display drive section 22, a left holding section 23, a left display drive section 24, a right optical image display section 26, and a left optical image display section 28.

The right optical image display section 26 and the left optical image display section 28 are respectively disposed in front of the right eye and the left eye of the user, and are integrally connected to each other at a position corresponding to an area between eyebrows of the user. The right holding section 21 extends from an end portion ER of the right optical image display section 26, and the left holding section 23 extends from an end portion EL of the left optical image display section 28.

The right holding section 21 is disposed beside the right side of the head of the user, and a tip thereof is engaged with the right ear of the user. Further, the left holding section 23 is disposed beside the left side of the head of the user, and a tip thereof is engaged with the left ear of the user. The head-mounted display device HM is supported by the tips of the right holding section 21 and the left holding section 23 and a nose pad section provided at a lower end of a junction section of the right optical image display section 26 and the left optical image display section 28.

The right display drive section 22 is built in a base end section of the right holding section 21, and the left display drive section 24 is built in a base end section of the left holding section 23. The head-mounted display device HM causes the right eye and the left eye of the user to view an image using the right display drive section 22 and the left display drive section 24, respectively.

A light adjusting plate 20A is provided on a front side, that is, on a front surface side of the right optical image display section 26 and the left optical image display section 28. The light adjusting plate 20A is detachably mounted to the right optical image display section 26 and the left optical image display section 28, and thus, plural types of light adjusting plates 20A may be mounted to be exchangeable. The light adjusting plate 20A is an optical element of a thin plate shape, and may employ various elements such as an element of which optical transparency is almost zero, an element that is approximately transparent, an element in which the intensity of light is attenuated to be transmitted, or an element that attenuates or reflects light of a specific wavelength. By appropriately selecting an optical characteristic of the light adjusting plate 20A, it is possible to adjust the intensity of outside light incident onto the right optical image display section 26 and the left optical image display section 28 from the outside. In the present embodiment, a case where the light adjusting plate 20A is used that has at least light transparency of such a degree that a user who wears the head-mounted display device HM can view the outside scene will be described. The light adjusting plate 20A also has a function of protecting a right light guide plate 261 and a left light guide plate 262 (to be described later) from damage, attachment of dirt or the like.

Further, on the front surface of the head-mounted display device HM, a camera 61 is disposed on a boundary portion between the right optical image display section 26 and the left optical image display section 28. The position of the camera 61 approximately corresponds to the center of the front surface of the head-mounted display device HM, which is an intermediate position of the left and right eyes of the user.

A photographing direction, that is, a view angle of the camera 61 is a front direction of the head-mounted display device HM, that is, a direction in which at least a part of an outside scene in a visual field direction of the user in a state where the user wears the head-mounted display device HM is photographed. Preferably, the photographing direction is a direction in which an outside scene range that the user views through a face 262A is photographed. Further, more preferably, a range of the camera 61 including the range viewed by the user through the face 262A is photographed. That is, it is preferable that the entire visual field of the user through the light adjusting plate 20A can be photographed.

The camera 61 intermittently photographs still images or photographs moving images, and outputs the photographed image data. The camera 61 in the present embodiment is shown as a single digital camera, but a stereo video camera that includes plural digital cameras may be employed.

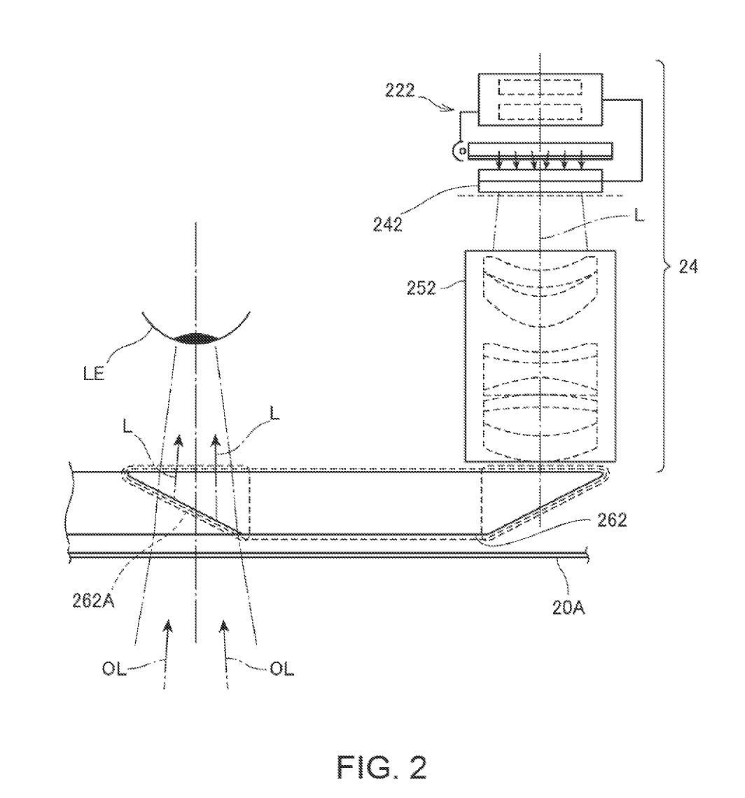

FIG. 2 is a diagram illustrating a schematic configuration of an optical system in the image display section 20. FIG. 2 is a plan view illustrating a configuration of the left display drive section 24 and the left light guide plate 262 that cause the left eye LE of the user to view a virtual image. Since respective configurations that cause the left eye and the right eye of the user to view the virtual image are laterally symmetrical, only the left display drive section 24 and the left light guide plate 262 will be described herein.

The left display drive section 24 of the image display section 20 includes a left backlight 222 that includes a light source such as an LED and a diffusion plate, a transmissive left liquid crystal display (LCD) 242 disposed on an optical path of light emitted from the diffusion plate of the left backlight 222, and a left projection optical system 252 that includes a lens group that guides an image light L that passes through the left LCD 242 and the like.

The left projection optical system 252 is formed by a collimator lens that forms the image light L emitted from the left LCD 242 into a parallel light flux. The image light L passed through the left projection optical system 252 is incident onto the left light guide plate 262. The left light guide plate 262 is a prism in which plural reflection surfaces that reflect the image light L are formed, in which the image light L is subjected to plural reflections in the left light guide plate 262 to be guided to the left eye LE. Further, the image light L reflected on the face 262A disposed in front of the left eye LE is emitted from the right optical image display section 26 toward the left eye LE, and the image light L forms an image on a retina of the left eye LE, to thereby cause the user to view the image.

Here, the left projection optical system 252 and the left light guide plate 262 are collectively referred to as a “light guide section”. The light guide section may use an arbitrary technique as long as a virtual image is formed in front of the eyes of the user using the image light, and for example, may use a diffraction grating or a semi-transmission reflection film.

The face 262A is configured by a half mirror. Thus, an outside light OL that passes through the light adjusting plate 20A, in addition to the image light L reflected on the face 262A, is incident onto the left eye LE of the user. That is, in the head-mounted display device HM, the image light L of the image processed therein and the outside light OL overlap each other to be incident onto the eyes of the user. Thus, the user may view the outside scene through the light adjusting plate 20A of the head-mounted display device HM, and thus, may view the image based on the image light L that overlaps with the outside scene. Thus, the head-mounted display device HM may be referred to as a see-through display device.

As the image light L guided to both eyes of the user of the head-mounted display device HM is formed on the retinas of the user, the user views a virtual image. Here, the visibilities of the outside scene and the virtual image in the user are influenced by balance of the intensities of light of the outside light OL and the image light L. In a case where the intensity of the outside light OL is higher than that of the image light L, the outside scene is more visible, but the visibility of the virtual image processed (displayed) by the head-mounted display device HM is low. On the other hand, in a case where the intensity of the image light L is higher than that of the outside light OL, the visibility of the outside scene is low while the visibility of the virtual image processed (displayed) by the head-mounted display device HM is high.

Thus, the head-mounted display device HM may change the visibility of the outside scene by changing the intensity of the image light L. As the method of changing the intensity of the image light L, for example, a method of changing the intensity of light emitted by the right backlight 221 and the left backlight 222 that are light sources, and a method of changing the transparency of the light in the right LCD 241 and the left LCD 242 may be used. Here, either of the methods may be used, or only any one of the methods may be used.

As the method of changing the light intensity of the right backlight 221 and the left backlight 222, a method of changing the luminance of the light source of each backlight, and a method in which a light intensity adjusting mechanism that causes each backlight to attenuate the light intensity by an extinction plate or the like and the light intensity is changed by operation of the light intensity adjusting mechanism may be used. Here, either of the methods may be used.

The transparency of the light in the right LCD 241 and the left LCD 242 is determined by the brightness of the display color of each pixel of the right LCD 241 and the left LCD 242. Accordingly, it is possible to adjust an optical transparency in each pixel by generally changing a color tone (brightness) of an image displayed in the right LCD 241 and the left LCD 242. This adjustment may be realized by an image processing technique that changes the color tone of the image.

Returning to FIG. 1, the head-mounted display device HM includes a connection section 40 that connects the image display section 20 to the control device 10. The connection section 40 includes a main body cable 48 connected to the control device 10, and two right and left cables 42 and 44 that are branched from the main body cable 48 through a connection member 46. The right cable 42 is inserted in a casing of the right holding section 21 and is connected to the right display drive section 22. The left cable 44 is inserted in a casing of the left holding section 23 and is connected to the left display drive section 24.

The image display section 20 and the control device 10 perform transmission of various signals through the connection section 40. For example, a metal cable or an optical fiber may be employed as the right cable 42, the left cable 44 and the main cable 48.

The control device 10 is a device for operating the head-mounted display device HM. The control device 10 includes a lighting section 12, a touch pad 14, a cross key 16, and a power source switch 18.

The lighting section 12 is provided with an indicator that includes an LED or the like, and notifies an operation state (for example, power ON/OFF or the like) of the head-mounted display device HM according to light emission state thereof. The touch pad 14 detects a contact operation through a finger of the user, and outputs a signal based on detection content. The cross key 16 is a key corresponding to up, down, left and right directions, and outputs a signal based on a pressing operation. The power source switch 18 is a switch that switches a power state of the head-mounted display device HM.

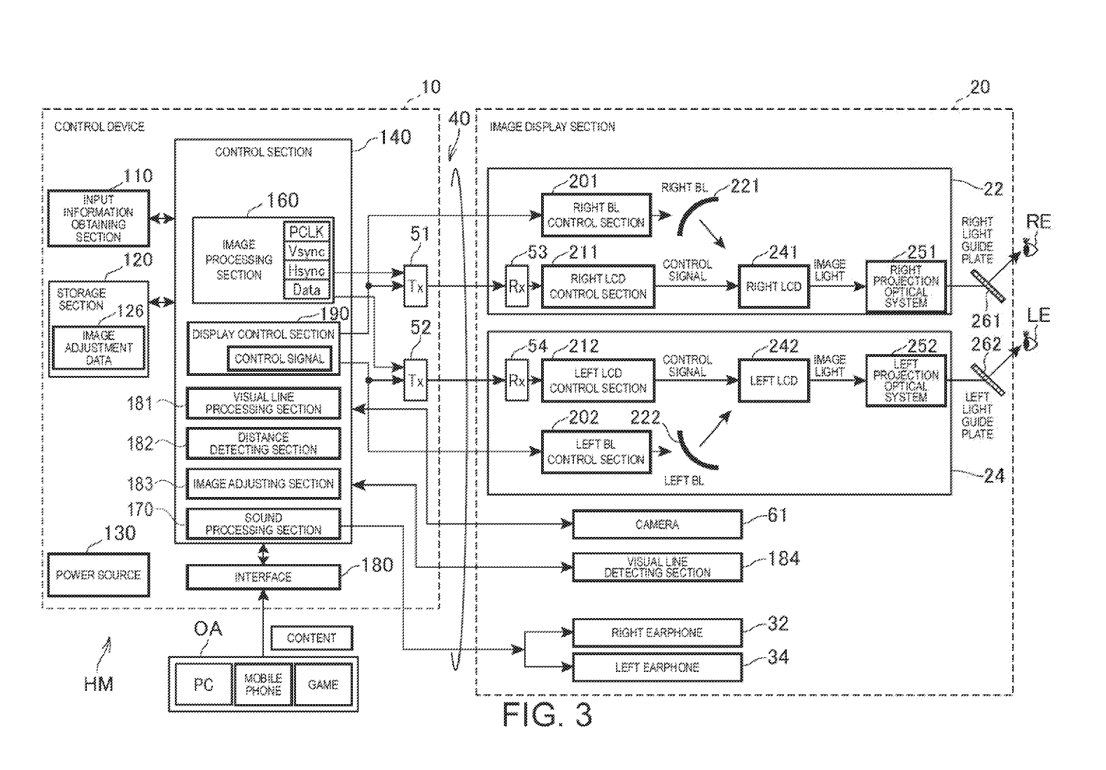

FIG. 3 is a functional block diagram illustrating a configuration of a control system of the head-mounted display device HM.

The control device 10 includes an input information obtaining section 110, a storage section 120, a power source 130, a control section 140, a communication interface 185, and transmission sections (Tx) 51 and 52. The respective sections are connected to each other through a bus (not shown).

The input information obtaining section 110 obtains signals based on inputs through the touch pad 14, the cross key 16, the power source switch 18 and the like, for example. The storage section 120 stores a program or data using a semiconductor memory element, a magnetic storage device or the like. The power source 130 includes a secondary battery, for example, and supplies power to the respective sections of the head-mounted display device HM.

The control section 140 includes a CPU, a ROM, a RAM or the like, and executes a program stored in the ROM or the storage section 120 to control the respective sections of the head-mounted display device HM. The control section 140 executes the program to also function as an image processing section 160, a visual line processing section 181, a distance detecting section 182 (distance detecting section), an image adjusting section 183 (control section), a sound processing section 170 and a display control section 190.

The image processing section 160 generates a signal to be supplied to the image display section 20 on the basis of content or the like input through the communication interface 185, and transmits the result to the image display section 20. In a case where an analog signal is input through the communication interface 185, the image processing section 160 performs an A/D conversion process to generate digital image data (Data), and outputs the result together with a clock signal (PCLK), a vertical synchronization signal (VSync) and a horizontal synchronization signal (HSync). Further, in a case where digital image data is input through the communication interface 185, the image processing section 160 performs various processes such as frame rate conversion or resolution conversion, and outputs the processed digital image data together with a clock signal, a vertical synchronization signal and a horizontal synchronization signal.

The signal output by the image processing section 160 is input to the right display drive section 22 of the image display section 20 through the transmission section 51, and is input to the left display drive section 24 through the transmission section 52.

The display control section 190 generates control signals that control the right display drive section 22 and the left display drive section 24. Specifically, the display control section 190 individually controls driving ON/OFF of the right LCD 241 using a right LCD control section 211, driving ON/OFF of a right backlight 221 using a right backlight control section 201, driving ON/OFF of the left LCD 242 using a left LCD control section 212, driving ON/OFF of a left backlight 222 using a left backlight control section 202, or the like according to the control signals, to thereby control generation and emission of image light in each of the right display drive section 22 and the left display drive section 24. For example, the display control section 190 causes both of the right display drive section 22 and the left display drive section 24 to generate image light, only one of them to generate image light, or neither of them to generate image light.

The display control section 190 transmits the control signals for the right LCD control section 211 and the left LCD control section 212 through the transmission sections 51 and 52, respectively. Further, the display control section 190 transmits the control signals for the right backlight control section 201 and the left backlight control section 202, respectively.

The sound processing section 170 obtains a sound signal included in content, amplifies the obtained sound signal, and supplies the amplified sound signal to a right earphone 32 and left earphone 34 of the image display section 20 through the connection section 40.

An interface 180 is an interface for connecting various external devices OA that are content supply sources to the control device 10. The interface 180 includes various connectors and interface circuits connected to the external devices OA of the head-mounted display device HM, and/or a wireless communication section and an interface circuit that transmit or receive a wireless signal to or from the external device OA. For example, the interface 180 may include an interface based on the USB standard, a memory card interface, a wireless communication interface based on the wireless LAN or Bluetooth (registered trademark) standard, a short-range wireless communication interface or the like. As the device OA, for example, a personal computer, a mobile phone terminal, a game machine or the like may be used. Further, a connector or the like for input of an analog signal may be provided in the interface 180.

The image display section 20 includes the right display drive section 22, the left display drive section 24, the right light guide plate 261 as the right optical image display section 26, the left light guide plate 262 as the left optical image display section 28, the camera 61, the right earphone 32 and the left earphone 34.

The right display drive section 22 includes a reception section (Rx) 53, the right backlight (BL) control section 201 and the right backlight (BL) 221, the right LCD control section 211 and the right LCD 241 that function as a display element, and the right projection optical system 251.

The reception section 53 receives a signal input from the transmission section 51. The right backlight control section 201 drives the right backlight 221 on the basis of a control signal input to the reception section 53. The right LCD control section 211 drives the right LCD 241 on the basis of a clock signal, a vertical synchronization signal, a horizontal synchronization signal and right eye image data input to the reception section 53. The right LCD 241 is a transmissive liquid crystal panel in which plural pixels are arranged in a matrix form, which is driven by the right LCD control section 211 to draw various images.

Similarly, the left display drive section 24 includes a reception section (Rx) 54, the left backlight (BL) control section 202 and the left backlight (BL) 222, the left LCD 242 that functions as a display element, and the left projection optical system 252.

The right backlight control section 201, the right LCD control section 211, the right backlight 221 and the right LCD 241 are collectively referred to as a right “image light generating section”, and the left backlight control section 202, the left LCD control section 212, the left backlight 222 and the left LCD 242 are collectively referred to as a left “image light generating section”. Further, the right holding section 21 and the left holding section 23 are collectively and simply referred to as a “holding section”, the right display drive section 22 and the left display drive section 24 are collectively and simply referred to as a “display drive section”, and the right optical image display section 26 and the left optical image display section 28 are collectively and simply referred to as an “optical image display section”.

Further, the display section according to the invention is configured by the display drive section and the image light generating section. The display section may include an optical image display section, or may include a light guiding section.

The reception section 54 receives a signal input from the transmission section 52. The left backlight control section 202 drives the left backlight 222 on the basis of a control signal input to the reception section 54. The left LCD control section 212 drives the left LCD 242 on the basis of a clock signal, a vertical synchronization signal, a horizontal synchronization signal and left eye image data input to the reception section 54. The left LCD 242 is a transmissive liquid crystal panel in which plural pixels are arranged in a matrix form, which is driven by the left LCD control section 212 to draw various images.

In the following description, the virtual image that the user views using the head-mounted display device HM is referred to as an “image”. This image is an image recognized by the user when images formed in the right LCD 241 and the left LCD 242 are formed on the retinas of the user. Further, the operation of the head-mounted display device HM that causes the user to view the virtual image is referred to as “display”.

The control section 140 displays images of a variety of content input through the communication interface 185 using the image display section 20. Further, when displaying image of content including sound, the control section 140 displays the image and outputs sound through the right earphone 32 and left earphone 34. Thus, the user may view and hear a variety of video content.

In the head-mounted display device HM of the present embodiment, it is possible to adjust the visibility of the outside scene viewed by the user through the light adjusting plate 20A while the image is being displayed. Particularly, the head-mounted display device HM of the present embodiment performs a process of detecting the visual line direction of the user and changing the visibility of the outside scene according to the detected visual line direction.

Further, the visual line detecting section 184 that is operated according to the control of the visual line processing section 181 is connected to the control section 140.

The visual line detecting section 184 is hardware for detecting the visual line direction of the user who wears the head-mounted display device HM, and is disposed in the image display section 20.

As the visual line detecting section 184, for example, an infrared camera that radiates infrared rays to the eyes of the user to photograph eyes by the infrared rays, a measuring device that performs electrical measurement of a cornea-retina electrical potential relating to eye movement, or the like may be used. For example, the visual line detecting section 184 is provided inside the image display section 20, that is, on the side of the right eye RE and the left eye LE, and executes photographing or measurement for detecting the visual line direction with respect to each of the right eye RE and the left eye LE. The visual line processing section 181 detects the visual line direction of the user using the visual line detecting section 184. Specifically, in a case where the visual line detecting section 184 is configured by the infrared camera, the visual line processing section 181 analyzes photographed image data of the visual line detecting section 184 to detect pupil and cornea reflection, to thereby calculate the visual line direction. Further, in a case where the visual line detecting section 184 is configured by the measuring device that performs the electrical measurement of the cornea-retina electric potential or the like, the visual line processing section 181 performs a process of removing components other than the visual line movement from the measurement value or the like, to thereby calculate the visual line direction.

The infrared camera or the measuring device that forms the visual line detecting section 184 may be provided on the image display section 20 only at a position corresponding to any one side of the right eye RE and the left eye LE. In this case, the visual line processing section 181 calculates the visual line direction of any one of the right eye RE and the left eye LE. Further, the visual line processing section 181 may calculate respective visual line directions of the right eye RE and the left eye LE of the user to output the visual line direction of each eye, or may perform a process of calculating an intermediate direction of the respective visual line directions, for example, on the basis of the visual line directions calculated for the right eye RE and the left eye LE to calculate one visual line direction as the visual line direction of both eyes for output. In the present embodiment, a case where the visual line processing section 181 outputs the respective visual line directions of the right eye RE and the left eye LE will be described.

Further, the control section 140 includes the distance detecting section 182 that detects the distance to an object positioned in front of the image display section 20, that is, in the photographing direction of the camera 61. The distance detecting section 182 detects the distance to the front object using a distance measuring function for adjusting a focus of the camera 61, for example. The distance detecting section 182 may include an infrared sensor or an ultrasonic sensor, and may detect the distance using the sensor.

The distance detecting section 182 detects the distance to the object positioned in the visual line direction calculated by the visual line processing section 181 in front of the image display section 20. In a case where the visual line processing section 181 detects respective visual line directions of the right eye RE and the left eye LE, the distance detecting section 182 may detect a distance to the object positioned in the visual line direction of the right eye RE and a distance to the object positioned in the visual line direction of the left eye LE, respectively. Further, the distance detecting section 182 may calculate a distance to the object positioned in the visual line direction of any predetermined one of the right eye RE and the left eye LE. Further, the distance detecting section 182 may calculate a visual line direction for detection on the basis of the visual line direction of the right eye RE and the visual line direction of the left eye LE, and may detect the distances to the object positioned in the calculated direction.

The image adjusting section 183 adjusts the image light L (the intensity of the image light L, the color tone of the image or the like) on the basis of the visual line direction calculated by the visual line processing section 181 and/or the distance detected by the distance detecting section 182. Specific forms of adjustment performed by the image adjusting section 183 are exemplified as follows.

(1) The image adjusting section 183 adjusts the intensity of the image light L on the basis of the distance detected by the distance detecting section 182. Thus, according to whether the object positioned in the visual line direction of the user is distant or close, the visibility of the outside scene is changed. For example, if the intensity of the image light L is increased as the distance detected by the distance detecting section 182 is long, and if the intensity of the image light L is decreased as the distance detected by the distance detecting section 182 is short, it is possible to maintain the visibility of the image light L at a high level. In a case where a user views the far distance, since an image formed on the eyes of the user by the image light L looks big, there is a tendency that the image light L looks relatively dark, but it is possible to favorably view the image by the image light L by increasing the intensity of the image light L. The method of adjusting the intensity of the image light L by the image adjusting section 183 may include any one of a method of changing the light intensities of the right backlight 221 and the left backlight 222 and a method of changing the color tones of the images drawn in the right LCD 241 and the left LCD 242.

(2) The image adjusting section 183 adjusts a position where the image is displayed by the image light L on the basis of the visual line direction output by the visual line processing section 181. Specifically, the image adjusting section 183 changes a relative position of a drawable range where the image is drawable in the right LCD 241 and the left LCD 242 and an actually drawn image. Here, in a case where the image is drawn in the entire drawable range, the image adjusting section 183 may change the position of the image in the drawable range with the image being reduced. The image adjusting section 183 arranges the image to avoid the visual line direction output by the visual line processing section 181, for example. In this case, it is possible to cause the user to view the image so as not to impair the visibility of the object that the user views.

(3) The image adjusting section 183 adjusts the visibility of a part of the image formed by the image light L on the basis of the visual line direction output by the visual line processing section 181. Specifically, the image adjusting section 183 adjusts the color tone of the image to be dark so that the intensity of the image light L is decreased only at a region of a predetermined size of the images drawn in the right LCD 241 and the left LCD 242 that overlaps with each other in the visual line direction output by the visual line processing section 181. In this case, it is possible to secure the visibility in the direction that the user views without affecting the display position or size of the image.

Further, the image adjusting section 183 may detect the intensity of the outside light OL on the basis of photographed image data photographed by the camera 61 or data indicating the intensity of light received by an imaging element (not shown) of the camera 61, and may adjust the image on the basis of the intensity of the outside light OL. In this case, the image adjusting section 183 may adjust the intensity of the image light L on the basis of the intensity of the outside light OL to secure the visibility of the image formed by the image light L, and then, may perform the above-described adjustments (1) to (3). In this case, even though the intensity of the outside light OL is considerably changed by a surrounding environment, it is possible to obtain the above-described effects, that is, the effects of securing the visibility of the outside scene, maintaining the visibility of the image at a high level and the like.

Furthermore, the image adjusting section 183 may detect the color of the object positioned in the visual line direction of the user on the basis of the visual line direction output by the visual line processing section 181, and the photographed image data photographed by the camera 61, and may adjust the image on the basis of the color. For example, in a case where the color of the object positioned in the visual line direction of the user is a color with high luminance, the visibility of the object is high. Thus, in the above-described adjustments (1) to (3), the image adjusting section 183 increases the amount of adjustment when adjusting the image light L to enhance the visibility of the outside scene, and increases the amount of adjustment when adjusting the image light L to enhance the visibility of the image formed by the image light L. On the other hand, when the color of the object positioned in the visual line direction of the user is a color with low luminance, since the visibility of the object is low, the image adjusting section 183 changes the amount of adjustment in a reverse direction in the above-described adjustments (1) to (3). In this case, it is possible to reliably obtain the above-described effects, that is, the effects of securing the visibility of the outside scene, maintaining the visibility of the image at a high level and the like, in consideration of the influence on the visibility of the outside scene (object) based on the color of the object.

The content of the adjustment executed by the image adjusting section 183 is determined by image adjustment data 126 stored in the storage section 120. The image adjustment data 126 includes predetermined content relating to the adjustment method of the image light L, the amount of adjustment in a case where the intensity of the image light L or the position of the image is adjusted, parameters that indicate, in a case where the image light L is adjusted on the basis of plural factors (the above-described distance, the intensity of the outside light OL, the color and the like), weights for the respective factors, and the like.

The image adjusting section 183 executes any one of the adjustments (1) to (3) or an adjustment that is a combination of the adjustments (1) to (3) and the intensity of the outside light OL or the color of the object according to image adjustment data 126.

The control section 140 may obtain the image adjustment data 126 from an external device through the interface 180 to be stored in the storage section 120.

Further, the head-mounted display device HM may individually adjust the image light L corresponding to the right eye RE and the left eye LE of the user, or may perform a common adjustment for the right eye RE and the left eye LE.

In the case of the individual adjustment, the distance detecting section 182 detects the distance on the basis of the visual line direction of the right eye RE output by the visual line processing section 181. The image adjusting section 183 adjusts the light intensity of the right backlight 221 or the right eye image drawn in the right LCD 241 on the basis of the visual line direction of the right eye RE and/or the distance detected by the distance detecting section 182, to thereby adjust the image light L corresponding to the right eye RE. Similarly, with respect to the left eye LE, the distance detecting section 182 detects the distance on the basis of the visual line direction of the left eye LE output by the visual line processing section 181, and the image adjusting section 183 adjusts the intensity of the left backlight 222 or the left eye image drawn in the left LCD 242 on the basis of the distance and/or the visual line direction of the left eye LE, to thereby adjust the image light L corresponding to the left eye LE. In this case, for example, in a case where different right and left images are displayed like a stereoscopic image, it is possible to adjust the image light L without an uncomfortable feeling.

Further, as described above, the right backlight 221 and the left backlight 222 and the right LCD 241 and the left LCD 242 may be controlled in the same manner using visual line directions of both eyes calculated from the visual line directions of the right eye RE and the left eye LE by the visual line processing section 181. In this case, it is possible to easily perform the process, and thus, a display delay due to the process of adjusting the image light L or the like barely occurs.

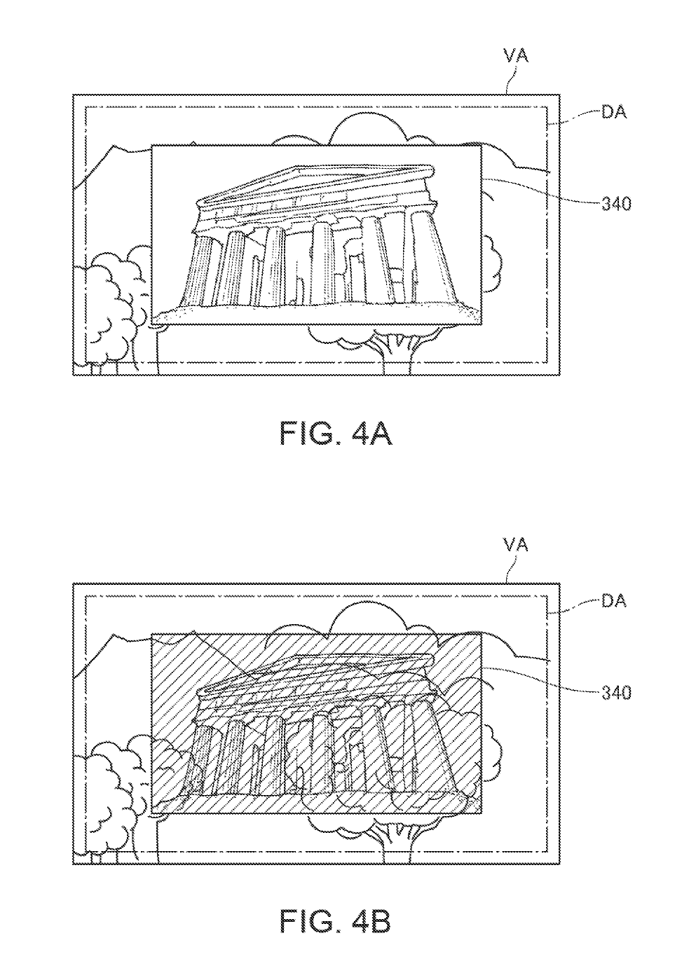

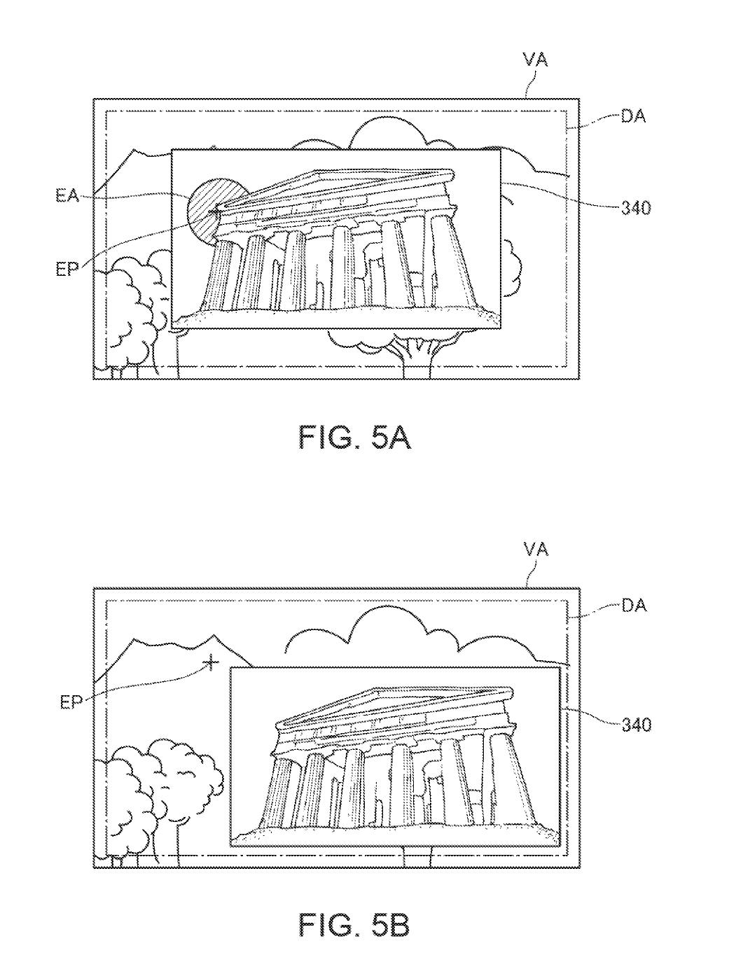

FIGS. 4A and 4B and FIGS. 5A and 5B are diagrams illustrating images displayed by the head-mounted display device HM, in which FIGS. 4A and 4B show an example in which the visibility of the outside scene is changed, and FIGS. 5A and 5B show an example in which a display mode at the position corresponding to the visual line direction is changed. FIGS. 4A and 4B and FIGS. 5A and 5B show images that a user views.

Reference sign VA in FIGS. 4A and 4B and FIGS. 5A and 5B represents a field of vision (visual field) of a user who wears the head-mounted display device HM, and reference sign DA represents a displayable area in the image display section 20. The displayable area DA represents a range where an image is viewed by the image light L, and is determined by displayable ranges of the right LCD 241 and the left LCD 242, the sizes of the right backlight 221 and the left backlight 222, optical characteristics of the right projection optical system 251, the left optical system 252, the right light guide plate 261 and the left light guide plate 262, and the like. In the present embodiment, the displayable area DA of a rectangular shape is present approximately at the center of the field of vision VA. The head-mounted display device HM may display an image in the displayable area DA.

In the example shown in FIG. 4A, an image 340 is displayed approximately at the center of the displayable area DA. The visibility of the outside scene is reduced in the range where the image 340 is displayed from the relationship between the luminance of the image 340 and the outside light OL.

The image adjusting section 183 performs an adjustment of reducing the intensity of the image light L for display of the image 340, as shown in FIG. 4B, for example, in a case where the distance detected by the distance detecting section 182 is close, or in similar cases. In this case, since the light intensity of the image 340 is reduced, the visibility of the outside scene is relatively enhanced.

Further, in the example shown in FIG. 5A, the periphery of the visual line direction of the user in the image 340 is adjusted so that the intensity of the image light L is reduced and the visibility of the outside scene is enhanced under the control of the image adjusting section 183. Since reference sign EP in FIG. 5A is illustrated for description of the visual line direction of the user, which is not displayed in the displayable area DA.

The image adjusting section 183 performs an adjustment so that an area EA of a predetermined size around the point EP that overlaps with the visual line direction is made dark. Thus, since the visibility of the outside light is enhanced at the area EA, the object that the user views is well viewable, and the visibility of the image 340 is maintained at a high level at the other portion.

In the example shown in FIG. 5B, the position of the image 340 at the displayable area DA is changed to avoid the point EP that overlaps with the visual line direction of the user under the control of the image adjusting section 183. In a case where the image 340 is larger than the displayable area DA and it is thus difficult to change the position of the image 340 to avoid the point EP, the image adjusting section 183 may change the position with the image 340 being reduced.

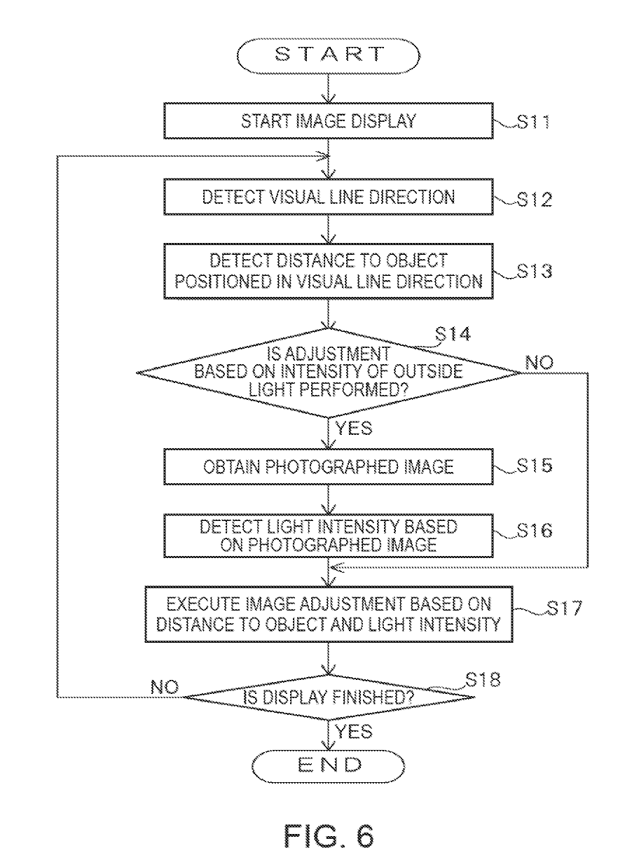

FIG. 6 is a flowchart illustrating an operation of the head-mounted display device HM, which is an operation of adjusting the image light L corresponding to the visual line of the user.

If an image display is instructed by operation of the touch pad 14 or the cross key 16 of the control device 10 in a state where power of the head-mounted display device HM is turned on, the control device 140 starts image display by the function of the display control section 190 (step S11).

If the image display is started, the visual line processing section 181 detects the visual line direction of the user using the visual line detecting section 184 (step S12), and the distance detecting section 182 detects the distance to the object positioned in the visual line direction (step S13).

Here, the image adjusting section 183 determines whether the adjustment based on the intensity of the outside light OL is performed, with reference to the image adjustment data 126 (step S14). If the adjustment based on the intensity of the outside light OL is performed (Yes in step S14), the image adjusting section 183 obtains the photographed image data of the camera 61 (step S15), and detects the intensity of the outside light OL on the basis of the photographed image data (step S16). Then, the image adjusting section 183 executes image adjustment on the basis of the detected intensity of the outside light OL, the visual line direction output by the visual line processing section 181 and/or the distance detected by the distance detecting section 182 (step S17).

Further, if the adjustment based on the intensity of the outside light OL is not performed (No in step S14), the image adjusting section 183 causes the procedure to proceed to step S17, and executes image adjustment on the basis of the detected intensity of the outside light OL, the visual line direction output by the visual line processing section 181 and/or the distance detected by the distance detecting section 182.

Then, the control section 140 determines whether an instruction for finishing the image display is input (step S18), and causes the procedure to return to step S12 in a case where the display is to be continued.

The control section 140 may intermittently execute the processes of step S12 to S17 to change the image light L any time while the image is being displayed. In this case, in a case where the object that the user views is changed, the image is adjusted according to the change, to thereby make it possible to maintain a preferable visibility. Further, in a case where the image light L is adjusted while the image is being displayed as in the above-described example, the image display may be stopped once. Further, the image adjusting section 183 may determine the content and amount of adjustment for adjusting the image light L, and then, may gradually increase the amount of adjustment from a current state of the image light L using the amount of adjustment as a target value. That is, in the adjustment of the image light L, a rapid change of the image light L may be prevented so that the image light L is gradually changed.

As described above, since the head-mounted display device HM according to the embodiment to which the invention is applied includes the display section that outputs the image light to overlap with the outside light OL and causes the image to be viewed, the distance detecting section 182 that detects the distance to the object positioned in the visual line direction of the user, and the image adjusting section 183 that changes the image light output by the display section according to the distance detected by the distance detecting section 182, it is possible to view the image while securing the visibility of the object viewed by the user together with the image light. Thus, it is possible to cause the outside light OL and the image based on the image light to be favorably viewed.

Further, since the image adjusting section 183 changes the image light so that the visibility of the object is changed according to the distance detected by the distance detecting section 182, it is possible to appropriately adjust the image light to match the object viewed by the user, and it is thus possible to cause the outside light OL and the image based on the image light to be favorably viewed. Specifically, the image adjusting section 183 changes the intensity of the image light according to the distance detected by the distance detecting section 182. Thus, it is possible to omit an effort of the user for setting the distance to the object, and to enhance the operability.

Further, the image adjusting section 183 may change the intensity of the image light on the basis of the intensity of the outside light OL that is incident in the visual line direction of the user. In this case, it is possible to appropriately secure the intensity balance of the outside light OL and the image light, and to cause both of the outside light OL and the image light to be favorably viewed.

Further, the image adjusting section 183 may change the position where the image is viewed to match the visual line direction of the user. In this case, it is possible to cause the image to be favorably viewed although the visual line of the user is changed.

Further, the image adjusting section 183 may detect the color of the object positioned in the visual line direction of the user, and may change the image light on the basis of the detected color of the object. In this case, it is possible to adjust the image light so that both of the outside light OL and the image light are easily viewed according to the color of the object.

The above-described embodiment is an example to which the invention is applied, and the configuration and the application range of the invention are not limited to the configuration of the above-described embodiment. For example, a specific configuration that adjusts the image light L is not limited to the examples shown in FIG. 4B and FIGS. 5A and 5B, and the image light L may be adjusted by other methods. Further, the invention is not limited to a case where a general image like the image 340 shown in FIGS. 4A and 4B and FIGS. 5A and 5B is displayed. For example, the invention may be applied to a case where an input auxiliary image that is generated by the head-mounted display device HM for supporting an input operation, such as a virtual keyboard or the like, is displayed. Further, a specific method of detecting the visual line direction of the user by the visual line processing section 181 and the visual line detecting section 184, a specific method of detecting the distance to the object positioned in the visual line direction of the user by the distance detecting section 182, a method of detecting the intensity of the outside light OL by the image adjusting section 183, and the like, are not limited to the above examples, and arbitrary methods may be employed.

Further, in the above-described embodiment, the configuration in which the image display section 20 that a user wears like glasses is provided has been described as an example, but the invention is not limited thereto. An image display section that a user wears like a cap, an image display section assembled in a helmet, or the like, instead of the image display section 20, may be provided. Further, the earphones 32 and 34 may employ an ear hook type or a head band type, or may be removed.

Further, in the above-described embodiment, the configuration has been described as an example in which the image display section 20 and the control device 10 are separated from each other and are connected to each other through the connection section 40, but the control device 10 and the image display section 20 may be integrally formed to be mounted on the head of the user. Further, the control device 10 and the image display section 20 may be connected to each other by a long cable or a wireless communication line. As the control device 10, a display of a notebook computer, a tablet computer or a desktop computer, a portable electronic device including a game machine, a mobile phone, a smart phone or a portable media player, a display included in other exclusive devices, or the like may be used.

Further, in the above-described embodiment, for example, the configuration has been described in which the image light generating section includes the right backlight 221, the left backlight 222, the right backlight control section 201, the left backlight control section 202, the right LCD 241, the left LCD 242, the right LCD control section 211 and the left LCD control section 212. This embodiment is merely an example, and thus, the image light generating section may include a configuration for realizing a different method together with the above configuration or instead of the configuration. For example, the image light generating section may have a configuration that includes a self-luminous display such as an organic electro-luminescence (EL) panel, and a control section that controls light emission thereof. Further, the image light generating section may use LCOS (liquid crystal on silicon; registered trademark), a digital micro-mirror device (DMD) or the like, instead of the LCD. In this case, the image light generating section includes a light source such as LEDs, and modulates light emitted from the light source by the LCOS or DMD to generate image light.

Further, for example, it is also possible to apply the invention to a head-mounted display of a laser retinal projection type. That is, the image light generating section may be configured to include a laser light source and an optical system that guides the laser light source to the eyes of the user, and to cause laser light to be incident onto the eyes of the user for scanning on the retinas to form images on the retinas so that the user can view an image. In a case where the head-mounted display of the laser retinal projection type is employed, an “area where image light can be emitted in the image light generating section” may be defined as an image area recognized by the eyes of the user.

The optical system that guides the image light generated by the image light generating section in the head-mounted display to the eyes of the user may be configured to include an optical member that transmits outside light that is incident onto the device from the outside, and to cause the outside light to be incident onto the eyes of the user together with the image light. Further, the optical system may employ an optical member that is disposed in front of the eyes of the user to overlap a part or all of the visual field of the user. Further, an optical system that uses a scan method that can scans laser light and the like as image light can be employed. Further, the optical system is not limited to a configuration that guides the image light inside the optical member, but may be configured to have a function of refracting and/or reflecting the image light toward the eyes of the user for guidance.

Further, the invention may be applied to a display device that uses a MEMS display technology.

The head-mounted display device HM of the embodiment has a configuration in which the light generated by the image light generating section including the right backlight 221, the left backlight 222, the right backlight control section 201, the left backlight control section 202, the right LCD 241, the left LCD 242, the right LCD control section 211 and the left LCD control section 212 is guided to the eyes of the user by the right light guide plate 261 and left light guide plate 262.

On the other hand, a scanning optical system using a MEMS mirror may be employed. That is, an image display element may includes a signal light forming section, a scanning optical system that has the MEMS mirror that scans light emitted from the signal light forming section, and an optical member that forms a virtual image by the light scanned by the scanning light optical system. In this configuration, the light emitted by the signal light forming section is reflected by the MEMS mirror, is incident onto the optical member, is guided in the middle of the optical member, and reaches a virtual image forming surface. As the MEMS mirror scans the light, a virtual image is formed on the virtual image forming surface. The user captures the virtual image by the eyes to recognize the image. The optical component in this case may be an element that guides light through plural reflections like the right light guide plate 261 and the left light guide plate 262 in the above-described embodiment, and the virtual image forming surface may be a half mirror surface like the face 262A.

Further, the display device of the invention is not limited to the display device of the above-described head-mounted display device, and may be applied to various display devices such as a flat panel display or a projector.

Since it is sufficient if the display device of the invention can cause the outside light and the image based on the image light to be viewed, the display device may have a configuration that causes the image based on the image light to be viewed by an optical member that transmits the outside light, for example. Specifically, instead of the configuration in which the optical member that transmits the outside light is provided in the head mounted display, the invention may be applied to a display device that projects image light onto a light-transmissive flat surface or curved surface (glass, transparent plastic or the like) that is fixedly or movably disposed at a position separated from the user. For example, a configuration of a display device that projects image light to a window glass of a vehicle and causes a user who is on the vehicle or outside the vehicle to view an image based on the image light and an outside scene inside or outside the vehicle may be used. Further, for example, a configuration of a display device that projects image light onto a fixedly disposed transparent, semitransparent or colored transparent display surface like a window glass of a building and causes a user who is present in the vicinity of the display surface to view an image based on the image light and a scene through the display surface may be used.

Further, the optical member that causes the image based on the image light to be viewed may use a light guiding body of a hologram reflex system, instead of a configuration using a light guiding body having a semitransparent surface, such as the light guide plates 261 and 262. In this case, as a light source that emits image light, a laser diode or an organic EL element with high interference may be used. Further, a configuration may be used in which a semi-transmissive reflection film or a hologram reflex system is provided on a surface of the optical member that does not have the function of guiding light to the inside positioned in the visual field of the user and image light is reflected by the surface toward the eyes of the user.

Further, the embodiment of the invention is not limited to the configuration in which the program executed by the control section 140 is stored in the storage section 120. For example, the program may be stored on a computer-readable portable recording medium, a storage device that is externally connected to the control device 10, or a device connected to the control device 10 through a wired or wireless communication line. In this case, the control device 10 may read the program for execution as necessary. Details of the other configurations of the head-mounted display device HM may be arbitrarily modified.

The entire disclosure of Japanese Patent Application No. 2013-000365, filed Jan. 7, 2013 is expressly incorporated by reference herein.

What is claimed is:

1. A display device comprising:
a display section that outputs an image light to overlap with an outside light and causes an image to be viewed;
a distance detecting section that detects a distance to an object positioned in a visual line direction of a wearer; and
a control section that changes the image light output by the display section according to the distance detected by the distance detecting section.

2. The display device according to claim 1,
wherein the control section changes the image light so that visibility of the object is changed according to the distance detected by the distance detecting section.

3. The display device according to claim 2,
wherein the control section changes the intensity of the image light according to the distance detected by the distance detecting section.

4. The display device according to claim 1,
wherein the control section changes the intensity of the image light on the basis of the intensity of the outside light that is incident in the visual line direction of the wearer.

5. The display device according to claim 1,
wherein the control section changes a position where the image is viewed to match the visual line direction of the wearer.

6. The display device according to claim 1, further comprising:
a color detecting section that detects a color of the object positioned in the visual line direction of the wearer,
wherein the control section changes the image light on the basis of the color of the object detected by the color detecting section.

7. The display device according to claim 1,
wherein the display device is a transmissive display device that causes a user to view an image,
wherein the display section includes:
an image light generating section that generates and emits image light for display of an image using display image data; and
an optical member that guides the emitted image light to eyes of the user, and
wherein the outside light passes through the optical member and is incident onto the eyes of the user together with the image light.

8. A control method of a display device that includes a display section that outputs an image light to overlap with an outside light and causes an image to be viewed, the method comprising:
detecting a distance to an object positioned in a visual line direction of a wearer; and
changing the image light output by the display section according to the detected distance.
